(19) United States
(12) Patent Application Publication
(10) Pub. No.: US 2026/0329920 A1
(43) Pub. Date: Oct. 22, 2026

(54) INFORMATION PROCESSING APPARATUS, INFORMATION PROCESSING METHOD, AND NON-TRANSITORY COMPUTER READABLE STORAGE MEDIUM

(71) Applicant: LY Corporation, Tokyo (JP)

(72) Inventors: Kohei UNO, Tokyo (JP); Yohei ISEKI, Tokyo (JP); Masamichi IMASEKI, Tokyo (JP); Yoshiaki HOMMA, Tokyo (JP)

(21) Appl. No.: 19/558,085

(22) Filed: Mar. 5, 2026

(30) Foreign Application Priority Data
Apr. 18, 2025 (JP) 2025-069029

(51) Int. Cl. G06F 16/34; G06F 16/3329; G06F 40/279

(52) U.S. Cl. CPC G06F 16/345; G06F 16/33295; G06F 40/279

(57) ABSTRACT

An information processing apparatus according to the present application includes a reception unit, a search unit, a summarization unit, and a generation unit. The reception unit receives a question text. The search unit searches a Q&A database including a question text and an answer text posted online for a plurality of pieces of information related to the question text received by the reception unit, as search targets. The summarization unit causes a language model to summarize the plurality of pieces of information obtained in the search by the search unit. The generation unit causes the language model to generate an answer text to the question text received by the reception unit based on the question text received by the reception unit and the summarization result obtained by the summarization unit.

### CROSS-REFERENCE TO RELATED APPLICATIONS

The present application claims priority to and incorporates by reference the entire contents of Japanese Patent Application No. 2025-069029 filed in Japan on Apr. 18, 2025.

### BACKGROUND OF THE INVENTION

### 1. Field of the Invention

The present invention relates to an information processing apparatus, an information processing method, and a non-transitory computer-readable storage medium.

### 2. Description of the Related Art

In recent years, there have been developed technologies of generating an answer text related to a question text from a user by using a language model such as a transformer model. For example, JP 7353695 B discloses a technique of causing a language model to generate an answer text to a question text.

However, the above-described conventional technology uses a group-wise pre-trained model as a language model that generates an answer text to a question text, and thus, has a problem in terms of learning cost.

### SUMMARY OF THE INVENTION

An information processing apparatus according to the present application includes a reception unit, a search unit, a summarization unit, and a generation unit. The reception unit receives a question text. The search unit searches a Q&A database including a question text and an answer text posted online for a plurality of pieces of information related to the question text received by the reception unit, as search targets. The summarization unit causes a language model to summarize the plurality of pieces of information obtained in the search by the search unit. The generation unit causes the language model to generate an answer text to the question text received by the reception unit based on the question text received by the reception unit and the summarization result obtained by the summarization unit.

It should be noted that some or all of the above-described means for solving the problem may be implemented using various artificial intelligence-related technologies and techniques, including, but not limited to, the use of various generative AI models implemented using machine learning, deep learning, large language models, and the like.

### BRIEF DESCRIPTION OF THE DRAWINGS

FIG. 1 is a diagram illustrating information processing according to an embodiment;

FIG. 2 is a diagram illustrating an example of a configuration of an information processing system according to the embodiment;

FIG. 3 is a diagram illustrating an example of a configuration of an information processing apparatus according to the embodiment;

FIG. 4 is a diagram illustrating an example of a user information table stored in a user information storage unit of the information processing apparatus according to the embodiment;

FIG. 5 is a diagram illustrating an example of a question text table included in a Q&A database stored in a Q&A information storage unit of the information processing apparatus according to the embodiment;

FIG. 6 is a diagram illustrating an example of an answer text table included in the Q&A database stored in the Q&A information storage unit of the information processing apparatus according to the embodiment;

FIG. 7 is a diagram illustrating an example of processing by a decision unit in a processing unit of the information processing apparatus according to the embodiment;

FIG. 8 is a diagram illustrating an example of processing of a summarization unit and a generation unit in the processing unit of the information processing apparatus according to the embodiment;

FIG. 9 is a flowchart illustrating an example of information processing performed by the processing unit of the information processing apparatus according to the embodiment; and

FIG. 10 is a hardware configuration diagram illustrating an example of a computer that implements functions of the information processing apparatus according to the embodiment.

### DETAILED DESCRIPTION OF THE PREFERRED EMBODIMENTS

Hereinafter, modes (hereinafter referred to as “embodiment”) for implementing an information processing apparatus, an information processing method, and a non-transitory computer-readable storage medium according to the present application will be described in detail with reference to the drawings. Note that the embodiment is not intended to limit the information processing apparatus, the information processing method, or the non-transitory computer-readable storage medium according to the present application. In addition, each embodiment can be appropriately combined within a range not causing contradiction in the processing. In the following embodiments, same parts are denoted by same reference numerals, and redundant description will be omitted.

### 1. Example of Information Processing

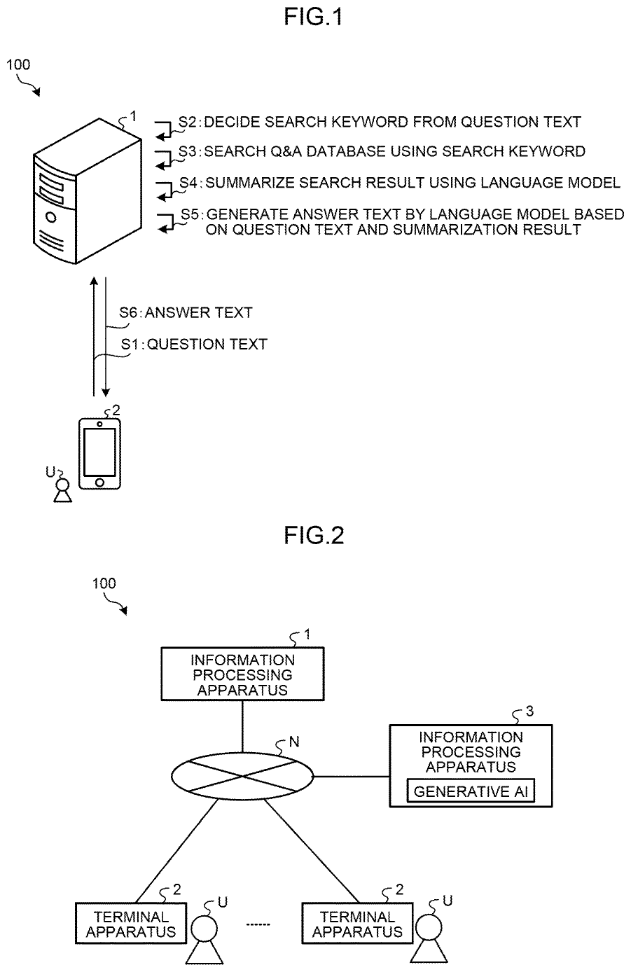

First, an example of information processing according to the embodiment will be described with reference to FIG. 1. FIG. 1 is a diagram illustrating information processing according to an embodiment.

As illustrated in FIG. 1, an information processing system 100 according to the embodiment includes an information processing apparatus 1 and a plurality of terminal apparatuses 2. The information processing apparatus 1 provides an online service including a question & answer (Q&A) service to a user U of the terminal apparatus 2.

The Q&A service is a service provided in such a scenario that a question text posted online by a questioner is received and disclosed online, and an answer text posted by an answerer to the question posted online by the questioner is received online and disclosed. The user U may be either a questioner or an answerer.

The information processing apparatus 1 has a Q&A database including data of question texts posted online by the questioner, data of answer texts posted online by the answerer, etc., and can perform automated generation of an answer text to the question text posted by the questioner, by using the Q&A database. Hereinafter, automated generation processing of an answer text performed by the information processing apparatus 1 will be described.

As illustrated in FIG. 1, the information processing apparatus 1 receives a question text posted by the user U as a questioner (step S1). By operating the terminal apparatus 2, the user U can input the question text to the terminal apparatus 2 so as to transmit the data of the question text from the terminal apparatus 2 to the information processing apparatus 1. Hereinafter, the question text received in step S1 may be denoted as a target question text for convenience.

Based on the target question text received in step S1, the information processing apparatus 1 decides a plurality of search keywords for searching for information related to the target question text as a search target (step S2).

In the processing of step S2, the information processing apparatus 1 performs, for example, extraction processing of extracting a plurality of keyword candidates that are candidates of the search keyword from the target question text. For example, the information processing apparatus 1 extracts a plurality of keyword candidates from the target question text using a language model. Examples of the language model include, but are not limited to, a Large Language Model (LLM). Hereinafter, the Large Language Model may be denoted as LLM.

For example, the information processing apparatus 1 inputs, to the LLM, information including a target question text and an instruction text instructing extraction of a plurality of keyword candidates from the target question text, as input information, thereby acquiring a plurality of keyword candidates output from the LLM. Examples of the instruction text include, but are not limited to, a character string “Extract keywords for search from the given question text”. The LLM may be included in the information processing apparatus 1. LLM may be used via an application programming interface (API). Furthermore, the instruction text includes an input/output example (few-shot), enhancing the output accuracy. However, the instruction text is not limited to such an example, and may include a text indicating a keyword candidate extraction condition.

The information processing apparatus 1 causes the language model to decide the search keyword based on the target question text and the plurality of keyword candidates extracted by the extraction processing described above. Examples of the language model include, but are not limited to, the LLM.

For example, the information processing apparatus 1 inputs, as input information, information including a target question text, a plurality of keyword candidates, and an instruction text to the LLM, and causes the LLM to select a predetermined number (for example, 4) of keyword candidates from among the plurality of keyword candidates as a plurality of search keywords.

The instruction text in this case is a text including an instruction to select, from among the plurality of keyword candidates, a predetermined number of keyword candidates in descending order from a most appropriate keyword as a search keyword for performing an appropriate search on the target question text. For example, examples of the instruction text include, but are not limited to, “Narrow down the question text and keyword group to four keywords appropriate in the search for questions.” Furthermore, the instruction text includes an input/output example (few-shot), enhancing the output accuracy. However, the instruction text is not limited to such an example, and may include a text indicating a keyword decision condition.

In this manner, the information processing apparatus 1 performs the processing by dividing the processing into two simple tasks of the extraction of the keyword candidate and the decision of the search keyword, making it possible to decide the search keyword with high accuracy. Note that the LLM used for extracting the keyword candidate and the LLM used for deciding the search keyword can be LLMs having mutually different calculation costs or use fees depending on the difficulty of each task.

Subsequently, using the search keyword decided in step S2, the information processing apparatus 1 searches the Q&A database including the question text and the answer text posted online for a plurality of pieces of information related to the target question text received in step S1 as a search target (step S3). In step S3, the information processing apparatus 1 performs the processing of searching the Q&A database for information related to the target question text as a search target using the search keyword, for each search keyword.

In step S3, for example, the information processing apparatus 1 acquires a plurality of combinations of a question text related to the target question text and one or more answer texts associated with the question text from the Q&A database, as information related to the target question text. For example, the information processing apparatus 1 acquires, from the Q&A database, m question texts (m is an integer of 2 or more) in descending order from the one having highest relevance to the target question text, and one or more answer texts associated with each of these question texts.

Subsequently, the information processing apparatus 1 causes the language model to summarize the search result, being a plurality of pieces of information obtained in the search in step S3 (step S4). For example, the information processing apparatus 1 uses LLM to summarize a search result, being a plurality of pieces of information searched in step S3. With such a summary, unnecessary information can be deleted and necessary information can be extracted.

For example, the information processing apparatus 1 inputs information, which includes the plurality of pieces of information searched in step S3 and an instruction text instructing summarization of the plurality of pieces of information, to LLM as input information, thereby causing the LLM to output a summary of the plurality of pieces of information searched in step S3. Such an LLM is an example of a first language model.

Furthermore, the information processing apparatus 1 can cause the LLM to output a summary of the plurality of pieces of information searched in step S3 by inputting information further including the target question text to the LLM as input information. In this case, the instruction text includes, for example, information of a character string “Perform summarization so that the summarized information can be used as reference information to answer to the following questions.”, but is not limited to such an example. In this manner, by including the target question text, even in a case where noise is included in the search result, appropriate extraction by performing narrowing down to the information necessary for the answer to the target question text can be performed.

Subsequently, the information processing apparatus 1 causes the language model to generate an answer text to the target question text based on the target question text received in step S1 and the summarization result in step S4 (step S5). For example, the information processing apparatus 1 inputs information including a target question text, a summarization result, and an instruction text instructing generation of an answer text to the target question text using the summarization result as reference information to the LLM as input information, and causes the LLM to output the answer text to the target question text.

An example of the instruction text in this case may be, but is not limited to, a character string “A question text is given, so output an answer text to the question text. In addition, an example of an answer to a question text that may be useful as a reference will be given. Create an answer based on this answer example”. Furthermore, the instruction text includes an input/output example (few-shot), enhancing the output accuracy. However, the instruction text is not limited to such an example, and may include a text indicating a generation condition of the target question text.

The LLM used in generating the answer text to the target question text is an example of a second language model, and has a higher calculation cost or use fee than the LLM used in the summarization in step S4. The summarization in step S4 is relatively simple processing, and by using an LLM with a low calculation cost or use fee as the LLM used in summarizing the search result, the calculation cost or use fee can be suppressed. By using an LLM taking a high calculation cost or a high use fee as the LLM used in generating the answer text in step S5, the accuracy of the generated answer text can be enhanced.

Subsequently, the information processing apparatus 1 provides the user U with the answer text generated in step S5 (step S6). For example, the information processing apparatus 1 provides the answer text generated in step S5 to the user U by disclosing the answer text generated in step S5 in association with the question text received in step S1 or transmitting the answer text to the terminal apparatus 2 of the user U.

In this manner, the information processing apparatus 1 searches the Q&A database for a plurality of pieces of information related to the target question text as search targets, and causes the language model to summarize the plurality of pieces of information obtained in the search. Subsequently, the information processing apparatus 1 causes the language model to generate an answer text to the target question text based on the target question text and the summarization result. This makes it possible for the information processing apparatus 1 to provide an appropriate answer text to the question text without using the group-wise pre-trained model.

Hereinafter, the configuration etc. of the information processing system 100 including the information processing apparatus 1 and the terminal apparatus 2 that perform such processing will be described in detail.

### 2. Configuration of Information Processing System 100

FIG. 2 is a diagram illustrating an example of a configuration of the information processing system 100 according to the embodiment. As illustrated in FIG. 2, the information processing system 100 according to the embodiment includes an information processing apparatus 1, a plurality of terminal apparatuses 2, and an information processing apparatus 3.

The plurality of terminal apparatuses 2 are used by mutually different users U. The terminal apparatus 2 is, for example, a notebook personal computer (PC), a desktop PC, a smartphone, a tablet PC, or a wearable device. Examples of the wearable device include, but are not limited to, a smart glass, a smart watch, etc.

Each of the information processing apparatus 1, the terminal apparatus 2, and the information processing apparatus 3 is communicably connected to each other in a wired or wireless connection via a network N. Incidentally, the information processing system 100 illustrated in FIG. 2 may include a plurality of the information processing apparatuses 1 and a plurality of the information processing apparatuses 3.

Examples of the network N include, but are not limited to, a Wide Area Network (WAN) such as the Internet and a mobile communication network such as Long Term Evolution (LTE), 4th Generation (4G) mobile communication system, or 5th Generation (5G) mobile communication system.

The terminal apparatus 2 is connected to the network N via short-range wireless communication such as a mobile communication network, Bluetooth (registered trademark), or a wireless Local Area Network (LAN), so as to be able to communicate with the information processing apparatus 1 etc.

The information processing apparatus 3 includes generated AI such as LLM, and can provide the information processing apparatus 1 with use of the generative AI through the API.

### 3. Configuration of Information Processing Apparatus 1

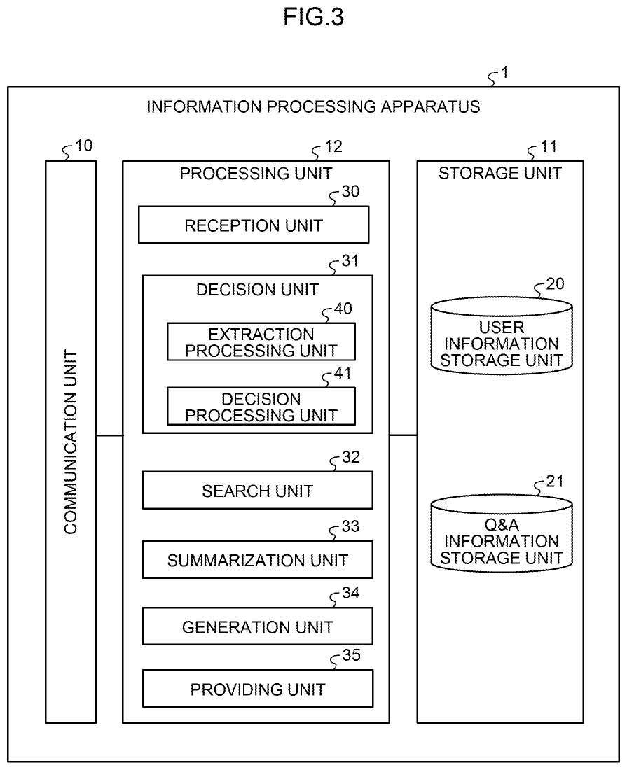

FIG. 3 is a diagram illustrating an example of a configuration of the information processing apparatus 1 according to the embodiment. As illustrated in FIG. 3, the information processing apparatus 1 includes a communication unit 10, a storage unit 11, and a processing unit 12.

### 3.1. Communication Unit 10

The communication unit 10 is implemented by a communication module, a network interface card (NIC), etc., for example. Subsequently, the communication unit 10 is connected to the network N in a wired or wireless connection, and transmits and receives information to and from various other devices. For example, the communication unit 10 transmits and receives information to and from the terminal apparatus 2 via the network N.

### 3.2. Storage Unit 11

The storage unit 11 is implemented by, for example, a semiconductor memory element such as Random Access Memory (RAM) or Flash Memory, or a storage apparatus such as a hard disk or an optical disk. The storage unit 11 includes a user information storage unit 20 and a Q&A information storage unit 21.

### 3.2.1. User Information Storage Unit 20

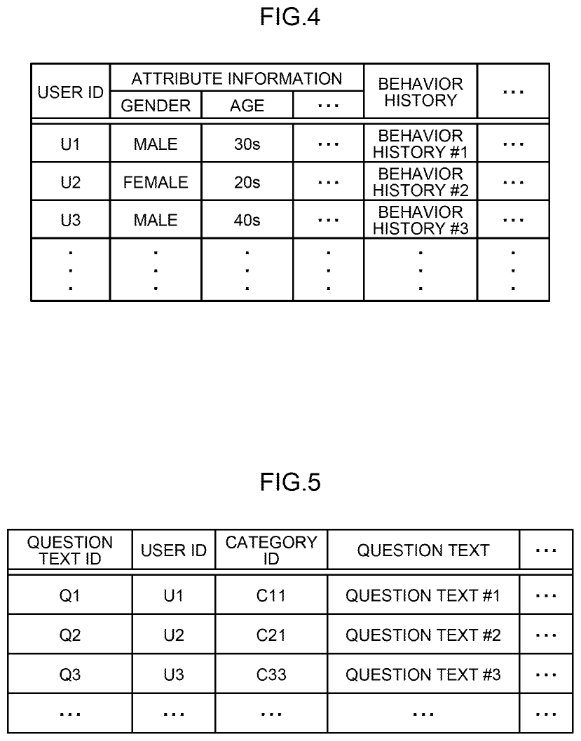

The user information storage unit 20 stores user information including information related to the user U. FIG. 4 is a diagram illustrating an example of a user information table stored in the user information storage unit 20 of the information processing apparatus 1 according to the embodiment. As illustrated in FIG. 4, the user information table stored in the user information storage unit 20 includes items such as “user ID”, “attribute information”, and “behavior history”.

The “user ID” is identification information that identifies the user U. The “attribute information” is attribute information of the user U corresponding to the “user ID”, and includes psychographic attribute information, demographic attribute information, etc., for example. The demographic attribute is gender, age, place of residence, occupation, etc., for example, and the psychographic attribute is an object of interest such as travel, clothes, cars, and religion, or a lifestyle, a way of thinking, tendency of thinking, etc.

The “behavior history” is a behavior history of the user U corresponding to the “user ID”. The behavior history of the user U includes, for example, a history of past selections (click operations, tap operations, etc.) by the user U of a link included in second distribution content provided to the user U by the processing unit 12 of the information processing apparatus 1. The behavior history of the user U further includes information such as a search history, a browsing history, a posting history, and a purchase history as the behavior history of the user U in the online service, for example.

### 3.2.2. Q&A Information Storage Unit 21

The Q&A information storage unit 21 stores a plurality of pieces of Q&A information. The Q&A information includes one or more answer texts for each question text. In a case where there is no post of an answer text to the question text, the Q&A information includes only the question text. For example, the Q&A information storage unit 21 stores a Q&A database including a question text table and an answer text table in a searchable manner.

FIG. 5 is a diagram illustrating an example of a question text table included in a Q&A database stored in the Q&A information storage unit 21 of the information processing apparatus 1 according to the embodiment. As illustrated in FIG. 5, the question text table stored in the Q&A information storage unit 21 includes items such as “question text ID”, “user ID”, “category ID”, and “question text”.

The “question text ID” is identification information that identifies the question text. The “user ID” is the user ID of the user U who has posted the question text corresponding to the “question text ID”. The “category ID” is identification information that identifies a category in which a question text corresponding to the “question text ID” is posted. The “question text” is a question text corresponding to the “question text ID”, and is text data, for example.

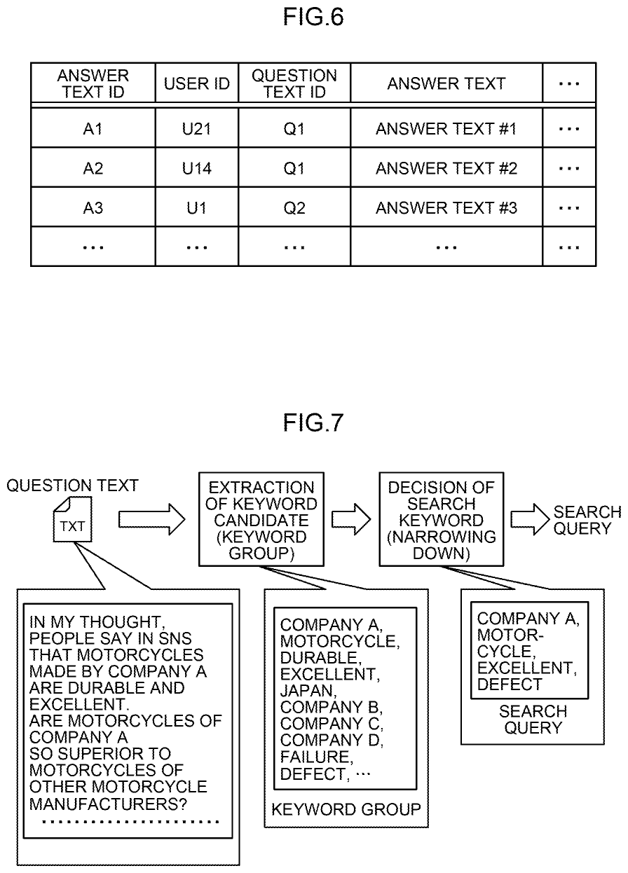

FIG. 6 is a diagram illustrating an example of an answer text table included in the Q&A database stored in the Q&A information storage unit 21 of the information processing apparatus 1 according to the embodiment. As illustrated in FIG. 6, the answer text table stored in the Q&A information storage unit 21 includes items such as “answer text ID”, “user ID”, “question text ID”, and “answer text”.

The “answer text ID” is identification information that identifies the answer text. The “user ID” is the user ID of the user U who has posted the answer text corresponding to the “answer text ID”. The “question text ID” is a question text ID of a question text associated with an answer text corresponding to the “answer text ID”. The “answer text” is an answer text corresponding to the “answer text ID”, and is text data, for example.

### 3.3. Processing Unit 12

The processing unit 12 is a controller, and is implemented by, for example, a processor such as a Central Processing Unit (CPU) or a Micro Processing Unit (MPU) executing various programs (corresponding to an example of an information processing program) stored in a storage apparatus inside the information processing apparatus 1 using the RAM, etc. as a work area.

Furthermore, the processing unit 12 is a controller, and may be partially or entirely implemented by an integrated circuit such as an Application Specific Integrated Circuit (ASIC), a Field Programmable Gate Array (FPGA), or a General Purpose Graphic Processing Unit (GPGPU).

As illustrated in FIG. 3, the processing unit 12 includes a reception unit 30, a decision unit 31, a search unit 32, a summarization unit 33, a generation unit 34, and a providing unit 35, and implements or executes a function and an action of information processing described below. The internal configuration of the processing unit 12 is not limited to the configuration illustrated in FIG. 3, and may be another configuration as long as it performs information processing described below.

### 3.3.1. Reception Unit 30

The reception unit 30 receives various types of information, requests, etc. The reception unit 30 receives, for example, various types of information and requests transmitted from the terminal apparatus 2 of the user U.

The reception unit 30 receives, for example, a question text or an answer text posted by the user U. For example, the reception unit 30 receives a question text or an answer text posted by the user U by receiving data of a question text or data of an answer text transmitted from the terminal apparatus 2 of the user U.

### 3.3.2. Decision Unit 31

The decision unit 31 makes various decisions. For example, the decision unit 31 decides the search keyword to be used by the search unit 32 based on the question text received by the reception unit 30. The search keyword includes one or more keywords.

The decision unit 31 includes an extraction processing unit 40 and a decision processing unit 41. The extraction processing unit 40 extracts a keyword candidate that is a candidate for the search keyword from the target question text that is the question text received by the reception unit 30. For example, the extraction processing unit 40 extracts a plurality of keyword candidates from the target question text using a language model. Examples of the language model include, but are not limited to, the LLM. For example, the language model may be Bidirectional Encoder Representations Transformers (BERT), for example.

For example, the extraction processing unit 40 inputs, to the LLM, information including a target question text and an instruction text instructing extraction of a plurality of keyword candidates from the target question text, as input information, thereby acquiring a plurality of keyword candidates output from the LLM. Examples of the instruction text include, but are not limited to, a character string “Extract keywords for search from the given question text”. Furthermore, the LLM may be included in the information processing apparatus 1, or the LLM of the information processing apparatus 3 may be used via an API. Furthermore, the instruction text includes an input/output example (few-shot), enhancing the output accuracy. However, the instruction text is not limited to such an example, and may include a text indicating a keyword candidate extraction condition.

The extraction processing unit 40 can also extract a keyword candidate from the target question text by natural language processing other than LLM. The natural language processing is morphological analysis, Term Frequency Inverse Document Frequency (TF-IDF), etc.

For example, the extraction processing unit 40 can set each word (for example, nouns and noun phrases) extracted from the target question text by the morphological analysis, as a keyword candidate. Furthermore, in a case of using the TF-IDF, the extraction processing unit 40 calculates a score for each word in the question text of the same category, and extracts a keyword candidate from the target question text based on the score. For example, the extraction processing unit 40 sets a word having a score equal to or higher than a threshold as a keyword candidate, or sets each of words having top m scores (m is 10 or more, for example) as a keyword candidate.

In addition, the decision processing unit 41 causes the language model to decide the search keyword based on the target question text that is the question text received by the reception unit 30 and the keyword candidate extracted by the extraction processing unit 40. Examples of the language model include, but are not limited to, the LLM.

For example, the decision processing unit 41 inputs, as input information, information including a target question text, a plurality of keyword candidates, and an instruction text to the LLM, and causes the LLM to select a predetermined number (for example, 4) of keyword candidates from among the plurality of keyword candidates as a plurality of search keywords.

The instruction text in this case is a text including an instruction to select, from among the plurality of keyword candidates, a predetermined number of keyword candidates in descending order from a most appropriate keyword as a search keyword for performing an appropriate search on the target question text. For example, examples of the instruction text include, but are not limited to, “Narrow down the question text and keyword group to four keywords appropriate in the search for questions.” Furthermore, the instruction text includes an input/output example (few-shot), enhancing the output accuracy. However, the instruction text is not limited to such an example, and may include a text indicating a keyword decision condition.

In this manner, the decision unit 31 performs two-stage processing of extracting the keyword candidates and deciding the search keyword, and thus can decide a more appropriate search keyword for the question text. Note that the LLM used for extracting the keyword candidate and the LLM used for deciding the search keyword can be LLMs having mutually different calculation costs or use fees depending on the difficulty of each task.

Note that the decision unit 31 can also perform two-stage processing of, for example, extraction of a keyword candidate and decision of a search keyword by a single input to the LLM. Examples of the instruction text in this case include, but are not limited to, a character string “Extract as many keywords for search as possible from the given question text and output extracted keywords. Thereafter, narrow down the question texts and the extracted keywords to four keywords appropriate for searching the question.

FIG. 7 is a diagram illustrating an example of processing by the decision unit 31 in the processing unit 12 of the information processing apparatus 1 according to the embodiment. In the example illustrated in FIG. 7, a plurality of keyword candidates (a keyword group) is extracted from the question text, and the search keyword used for the search query is decided from the plurality of keyword candidates (the keyword group).

### 3.3.3. Search Unit 32

The search unit 32 performs various searches. For example, the search unit 32 searches the Q&A database including the question text and the answer text posted online for a plurality of pieces of information related to the target question text, which is the question text received by the reception unit 30, as the search target. The search unit 32 searches the Q&A database for a plurality of pieces of information using the search keyword decided by the decision unit 31, for example.

For example, the search unit 32 searches for, as the search target, a plurality of pieces of information each piece including a question text and an answer text, related to the target question text which is the question text received by the reception unit 30. Each piece of information includes a combination of a question text related to the target question text and one or more answer texts associated with the question text. The answer text associated with the question text is an answer text posted by the answerer to the question text.

For example, the search unit 32 acquires, from the Q&A database, m question texts (m is an integer of 1 or more) in descending order from the one having highest relevance to the target question text, and one or more answer texts associated with each of these question texts. Note that the search unit 32 can also acquire, from the Q&A database, only one or more answer texts associated with each question text having high relevance to the target question text.

Furthermore, for example, in a case where the question text includes information vectorized using an embedding model in the Q&A database, the search unit 32 performs embedding vectorization of the target question text using the embedding model, acquires a question text related to the target question text from the Q&A database by vector search, and acquires one or more answer texts associated with the question text.

### 3.3.4. Summarization Unit 33

The summarization unit 33 causes a language model to summarize the plurality of pieces of information obtained in the search by the search unit 32. With such a summary, unnecessary information can be deleted and necessary information can be extracted. Examples of the language model include, but are not limited to, the LLM. For example, the language model may be BERT, etc.

For example, the summarization unit 33 uses the LLM to summarize a search result, being a plurality of pieces of information obtained in the search by the search unit 32. For example, the summarization unit 33 inputs information including a plurality of pieces of information obtained in the search by the search unit 32 and an instruction text instructing summarization of the plurality of pieces of information to LLM as input information, thereby causing the LLM to output a summary of the plurality of pieces of information obtained in the search by the search unit 32. Such an LLM is an example of a first language model.

The information to be obtained in the search by the search unit 32 includes a question text and an answer text, related to the target question text. The summarization unit 33 causes the LLM to summarize the plurality of question texts and answer texts obtained in the search by the search unit 32. When the information obtained in the search by the search unit 32 does not include a question text related to the target question text, the summarization unit 33 causes the LLM to summarize the plurality of answer texts obtained in the search by the search unit 32.

For example, the summarization unit 33 inputs information including an instruction text, a target question text, and a plurality of pieces of information obtained in the search by the search unit 32 to the LLM as input information to cause the LLM to summarize the plurality of pieces of information obtained in the search by the search unit 32. Examples of the instruction text in this case include, but are not limited to, a character string “Several texts are given, so summarize the main points into about 200 characters. The summarized texts will be used as a reference text (reference information) to answer the given question texts.” In this manner, the instruction text includes a text instructing summarization of the plurality of pieces of information obtained in the search by the search unit 32 so that the summarized information can be used as reference information for the target question text.

In addition, the instruction text instructing summarization includes an instruction indicating “ignoring ethically problematic answers; ignore defamation, radical expressions, inappropriate expressions”, and thus functions as a filter for inappropriate information. This makes it possible to delete inappropriate expressions as unnecessary information, achieving filtering on the summarization details at the summary stage. This makes it possible to lead to enhancement of the quality of the finally generated text (the answer text to the target answer text).

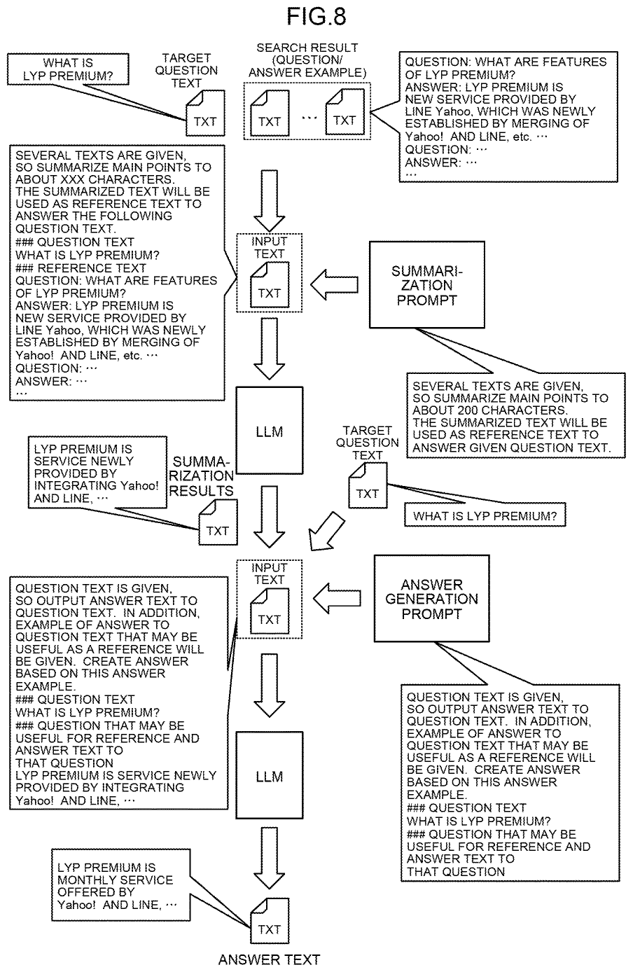

FIG. 8 is a diagram illustrating an example of processing of the summarization unit 33 and the generation unit 34 in the processing unit 12 of the information processing apparatus 1 according to the embodiment. As illustrated in FIG. 8, an input text including a target question text and a summarization prompt (instruction text instructing the summarization) is input to LLM, thereby causing the LLM to generate and output a summarization result (summarized texts).

In the example illustrated in FIG. 8, a target question text and a summarization prompt are input as a single input (for example, as a user message). However, the target question text may be input as a user message to the LLM and the summarization prompt may be input to the LLM as a system message.

### 3.3.5. Generation Unit 34

The generation unit 34 causes the language model to generate an answer text to the question text received by the reception unit 30 based on the question text received by the reception unit 30 and the summarization result obtained by the summarization unit 33. Examples of the language model include, but are not limited to, the LLM. LLM is an example of a second language model.

For example, the generation unit 34 inputs information including a target question text, a summarization result, and an instruction text instructing generation of an answer text to the target question text using the summarization result as reference information to the LLM as input information, and causes the LLM to output the answer text to the target question text. Such an LLM is an example of a second language model, and takes a higher calculation cost or use fee than an LLM used for summarization in the summarization unit 33.

An example of the instruction text in this case may be, but is not limited to, a character string “A question text is given, so output an answer text to the question text. In addition, an example of an answer to a question text that may be useful as a reference will be given. Create an answer based on this answer example”. Furthermore, the instruction text includes an input/output example (few-shot), enhancing the output accuracy. However, the instruction text is not limited to such an example, and may include a text indicating a generation condition of the target question text.

As illustrated in FIG. 8, an input text including a target question text, a summarization result (summarized text), and an answer generation prompt is input to the LLM, thereby causing the LLM to generate and output an answer text to the target question text. In the example illustrated in FIG. 8, the summarization result (summarized text) and the answer generation prompt are input as one input (for example, a user message), but the target question text and the summarization result (summarized text) may be input as a user message, and the answer generation prompt may be input to the LLM as a system message.

Examples of the LLM used for generating the answer text include, but are not limited to, an LLM taking a higher calculation cost or use fee than the LLM used for summarizing the search result. The summarization of the search result is relatively simple processing, and by using an LLM with a low calculation cost or use fee as the LLM used in summarizing the search result, the calculation cost or use fee can be suppressed. By using an LLM taking a high calculation cost or a high use fee as the LLM used in generating the answer text, the accuracy of the generated answer text can be enhanced.

Note that, in a case where there is no information related to the target question text in the Q&A database, the information obtained in the search by the search unit 32 may be zero. In this case, the generation unit 34 inputs information including a target question text and an instruction text instructing generation of an answer text to the target question text to the LLM as input information, and causes the LLM to output the answer text to the target question text. Examples of the instruction text in this case include, but are not limited to, a character string “A question text is given, so output an answer text to the question text.”

### 3.3.6. Providing Unit 35

The providing unit 35 provides various types of information to the user U. The providing unit 35 provides various types of information to the user U by transmitting various information to the terminal apparatus 2 of the user U.

For example, the providing unit 35 provides the user U with a question text posted by the questioner or an answer text posted by the answerer. Furthermore, the providing unit 35 provides the answer text generated by the generation unit 34 to the user U who has posted the target question text.

The providing unit 35 provides the user U with the answer text generated by the generation unit 34 by disclosing the answer text generated by the generation unit 34 in association with the target question text which is the question text received by the reception unit 30 or transmitting the answer text to the terminal apparatus 2 of the user U.

### 4. Processing procedure

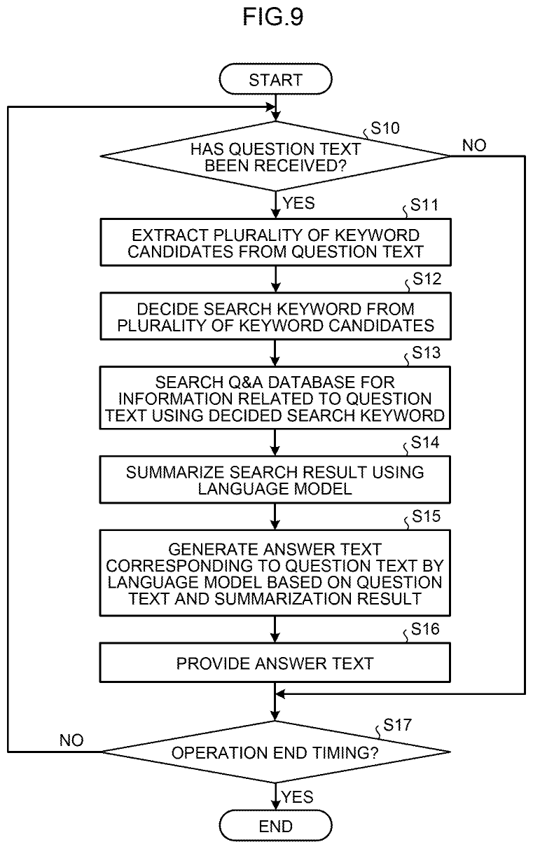

Next, a procedure of information processing performed by the processing unit 12 of the information processing apparatus 1 according to the embodiment will be described. FIG. 9 is a flowchart illustrating an example of information processing performed by the processing unit 12 of the information processing apparatus 1 according to the embodiment.

As illustrated in FIG. 9, the processing unit 12 determines whether a question text posted by the user U has been received (step S10). When having determined that the question text posted by the user U has been received (step S10: Yes), the processing unit 12 extracts a plurality of keyword candidates from the question text determined to have been received in step S10 (step S11).

Subsequently, the processing unit 12 decides a search keyword from among the plurality of keyword candidates decided in step S11 (step S12). Subsequently, the processing unit 12 uses the search keyword decided in step S12 to search the Q&A database for information related to the question text decided to have been received in step S10 (step S13).

Subsequently, the processing unit 12 summarizes the search result in step S13 using a language model (step S14). Subsequently, based on the target question text that is the question text determined to have been received in step S10 and the summarization result in step S14, the processing unit 12 generates an answer text related to the target question text using the language model (step S15). The processing unit 12 provides the user U with the answer text generated in step S15 (step S16).

When having finished the processing in step S16 or having determined that the question text posted by the user U has not been received (step S10: No), the processing unit 12 determines whether the operation end timing has come (step S17). For example, when the power of the information processing apparatus 1 is turned off, or having determined that an end operation has been performed by an operation on an operation unit (not illustrated) of the information processing apparatus 1, the processing unit 12 determines that the operation end timing has come.

When having determined that the operation end timing has not come (step S17: No), the processing unit 12 proceeds to the processing of step S10, and when having determined that the operation end timing has come (step S17: Yes), the processing unit 12 ends the processing illustrated in FIG. 9.

### 5. Modification

In the above-described example, the search unit 32 searches the Q&A database for information including a question text related to the target question text and an answer text associated with the question text, but search is not limited to this example. For example, the search unit 32 may search for information associated with the target question text using a search engine for web search. In this case, the summarization unit 33 can summarize the information obtained from the Q&A database and the information obtained in the search by the search engine, and the generation unit 34 can generate an answer text using the information summarized in this manner as reference information.

Furthermore, the search unit 32 can also search the Q&A database for the information by narrowing down the question texts to question texts posted by the questioner having an attribute same as or similar to the attribute (for example, one or more of age, gender, place of residence, etc.) of the user U who has posted the target question text among question texts related to the target question text.

Furthermore, the search unit 32 can also search the Q&A database for the information by narrowing down answer texts to answer texts having high evaluation from the questioner (for example, an answer text determined as a best answer) among answer texts associated with the question texts related to the target question text.

The generation unit 34 can also generate an answer text by an instruction text corresponding to the attribute of the user U who has posted the target question text. For example, an answer text is generated by an instruction text instructing expression corresponding to the age of the user U who has posted the target question text (for example, in a case where the user U who has posted the target question text is a middle school student, an instruction text including a character string “Give an answer in a manner such that even a middle school student can understand the answer.”)

### 6. Hardware Configuration

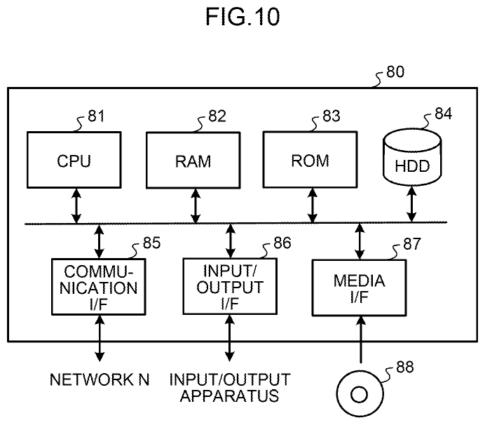

The information processing apparatus 1 according to the above-described embodiment is implemented by a computer 80 having a configuration as illustrated in FIG. 10, for example. FIG. 10 is a hardware configuration diagram illustrating an example of the computer 80 that implements functions of the information processing apparatus 1 according to the embodiment. The computer 80 includes a CPU 81, RAM 82, Read Only Memory (ROM) 83, a hard disk drive (HDD) 84, a communication interface (I/F) 85, an input/output interface (I/F) 86, and a media interface (I/F) 87.

The CPU 81 operates based on a program stored in the ROM 83 or the HDD 84, and controls each unit. The ROM 83 stores a boot program executed by the CPU 81 when the computer 80 is started, a program depending on hardware of the computer 80, etc.

The HDD 84 stores a program executed by the CPU 81, data used by the program, etc. The communication interface 85 receives data from other devices via the network N (refer to FIG. 2), transmits the data to the CPU 81, and transmits data generated by the CPU 81 to other devices via the network N.

The CPU 81 controls output apparatuses such as a display and a printer, and input apparatuses such as a keyboard and a mouse via the input/output interface 86. The CPU 81 acquires data from the input apparatus via the input/output interface 86. In addition, the CPU 81 outputs the generated data to the output apparatus via the input/output interface 86.

The media interface 87 reads a program or data stored in the recording medium 88 and provides the program or data to the CPU 81 via the RAM 82. The CPU 81 loads the program from the recording medium 88 onto the RAM 82 via the media interface 87, and executes the loaded program. Examples of the recording medium 88 include an optical recording medium such as a digital versatile disc (DVD) or a phase change rewritable disk (PD), a magneto-optical recording medium such as a magneto-optical disk (MO), a tape medium, a magnetic recording medium, and semiconductor memory.

For example, in a case where the computer 80 functions as the information processing apparatus 1 according to the embodiment, the CPU 81 of the computer 80 implements the function of the processing unit 12 by executing the program loaded on the RAM 82. In addition, the data in the storage unit 11 is stored in the HDD 84. The CPU 81 of the computer 80 executes these programs read from the recording medium 88, may acquire these programs from another apparatus via the network N, as another example.

### 7. Others

Among the processes described in the above embodiments, all or a part of the processes described as being automatically performed can be manually performed, or all or a part of the processes described as being manually performed can be automatically performed by a known method. In addition, the processing procedure, specific name, and information including various data and parameters illustrated in the document and the drawings can be flexibly changed unless otherwise specified. For example, the various types of information illustrated in each figure are not limited to the illustrated information.

In addition, individual components of each apparatus illustrated in the drawings are functionally conceptual, and are not necessarily to be physically configured as illustrated in the drawings. That is, specific forms of distribution and integration of each apparatus are not limited to the illustrated forms, and all or a part thereof can be functionally or physically distributed and integrated in any unit according to various loads, usage conditions, etc.

For example, the above-described information processing apparatus 1 may be implemented by a terminal apparatus and a server computer, may be implemented by a plurality of server computers, or may be implemented by calling an external platform, etc., with an API, network computing, etc. depending on functions, so that the configuration can be flexibly changed.

In addition, the embodiments and modifications described above can be appropriately combined with each other within a range not causing conflict of processing.

### 8. Effects

As described above, the information processing apparatus 1 according to the embodiment includes the reception unit 30, the search unit 32, the summarization unit 33, and the generation unit 34. The reception unit 30 receives a question text. The search unit 32 searches the Q&A database including the question text and an answer text posted online for a plurality of pieces of information related to the question text received by the reception unit 30 as search targets. The summarization unit 33 causes a language model to summarize the plurality of pieces of information obtained in the search by the search unit 32. The generation unit 34 causes the language model to generate an answer text to the question text received by the reception unit 30 based on the question text received by the reception unit 30 and the summarization result obtained by the summarization unit 33. This makes it possible for the information processing apparatus 1 to provide an appropriate answer text to the question text without using the group-wise pre-trained model.

The summarization unit 33 causes the first language model to summarize the plurality of pieces of information, and the generation unit 34 causes the second language model, which is different from the first language model, to generate an answer text to the question text received by the reception unit 30. This makes it possible for the information processing apparatus 1 to provide a more appropriate answer text to the question text.

The first language model is lower in calculation cost or use fee than the second language model. This makes it possible for the information processing apparatus 1 to provide an appropriate answer text to the question text while suppressing the cost.

The summarization unit causes the language model to summarize the plurality of pieces of information by inputting, to the first language model, information including the plurality of pieces of information, the question text received by the reception unit, and an instruction text instructing summarization of the plurality of pieces of information so that the summarized information can be used as reference information for the question text received by the reception unit. This makes it possible for the information processing apparatus 1 to appropriately extract only the information necessary for the answer to the target question text, and to appropriately summarize the question text even in a case where noise is included in the search result.

Each of the first language model and the second language model is an LLM. This makes it possible for the information processing apparatus 1 to provide a more appropriate answer text to the question text.

The search unit 32 searches, as a search target, a plurality of pieces of information each including a question text and an answer text, related to the question text received by the reception unit 30, and the summarization unit 33 causes the language model to summarize the plurality of question texts and the answer texts obtained in the search by the search unit 32. This makes it possible for the information processing apparatus 1 to provide a more appropriate answer text to the question text.

The information processing apparatus 1 according to the embodiment further includes the decision unit 31 that decides a search keyword to be used by the search unit 32 based on the question text received by the reception unit 30, and the search unit 32 searches for a plurality of pieces of information using the search keyword decided by the decision unit 31. This makes it possible for the information processing apparatus 1 to provide a more appropriate answer text to the question text.

The decision unit 31 includes: the extraction processing unit 40 that extracts a keyword candidate that is a candidate of the search keyword from the question text received by the reception unit 30; and the decision processing unit 41 that causes the language model to decide the search keyword based on the question text received by the reception unit 30 and the keyword candidate extracted by the extraction processing unit 40. This makes it possible for the information processing apparatus 1 to provide a more appropriate answer text to the question text.

The decision processing unit 41 decides the search keyword using LLM. This makes it possible for the information processing apparatus 1 to provide a more appropriate answer text to the question text.

The embodiments of the present application have been described in detail with reference to the drawings as above. However, they are merely examples, and the present invention can be implemented in other forms subjected to various modifications and improvements based on the knowledge of those skilled in the art, including the aspects described in the field of disclosure of the invention.

In addition, the “the terms representing portions (sections, modules, units)” described above can be rephrased as other terms such as “means” and “circuits”. For example, the acquisition unit can be replaced with an acquisition means or an acquisition circuit.

What is claimed is:

1. An information processing apparatus comprising:
a reception unit that receives a question text;
a search unit that searches a Q&A database including a question text and an answer text posted online for a plurality of pieces of information related to the question text received by the reception unit, as a search target;
a summarization unit that causes a language model to summarize the plurality of pieces of information obtained in the search by the search unit; and
a generation unit that causes a language model to generate an answer text to the question text received by the reception unit based on the question text received by the reception unit and a summarization result obtained by the summarization unit.

2. The information processing apparatus according to claim 1,
wherein the summarization unit causes a first language model to summarize the plurality of pieces of information, and
the generation unit causes a second language model, which is different from the first language model, to generate the answer text to the question text received by the reception unit.

3. The information processing apparatus according to claim 2,
wherein the first language model is lower in calculation cost or use fee than the second language model.

4. The information processing apparatus according to claim 2,
wherein each of the first language model and the second language model is an LLM.

5. The information processing apparatus according to claim 4,
wherein the summarization unit causes the language model to summarize the plurality of pieces of information by inputting, to the first language model, information including the plurality of pieces of information, the question text received by the reception unit, and an instruction text instructing summarization of the plurality of pieces of information so that the summarized information can be used as reference information for the question text received by the reception unit.

6. The information processing apparatus according to claim 1,
wherein the search unit searches for a plurality of pieces of information each including a question text and an answer text, related to the question text received by the reception unit, as the search target; and
the summarization unit causes the language model to summarize the plurality of pieces of information obtained in the search by the search unit.

7. The information processing apparatus according to claim 1, further comprising
a decision unit that decides a search keyword to be used by the search unit, based on the question text received by the reception unit,
wherein the search unit searches for the plurality of pieces of information by using the search keyword decided by the decision unit.

8. The information processing apparatus according to claim 7,
wherein the decision unit includes:
an extraction processing unit that extracts a keyword candidate, which is a candidate of the search keyword, from the question text received by the reception unit; and
a decision processing unit that causes the language model to decide the search keyword based on the question text received by the reception unit and the keyword candidate extracted by the extraction processing unit.

9. The information processing apparatus according to claim 8,
wherein the decision processing unit decides the search keyword by using an LLM.

10. An information processing method executed by a computer, the method comprising:
receiving a question text;
searching a Q&A database including a question text and an answer text posted online for a plurality of pieces of information related to the question text obtained by the reception, as a search target; and
causing a language model to summarize the plurality of pieces of information obtained by the searching; and
causing a language model to generate an answer text to the question text obtained by the reception based on the question text obtained by the reception and a summarization result obtained by the summarization.

11. A non-transitory computer-readable storage medium storing an information processing program, the program causing a computer to execute processing comprising:
receiving a question text;
searching a Q&A database including a question text and an answer text posted online for a plurality of pieces of information related to the question text obtained by the reception, as a search target; and
causing a language model to summarize the plurality of pieces of information obtained by the searching; and
causing a language model to generate an answer text to the question text obtained by the reception based on the question text obtained by the reception and a summarization result obtained by the summarization.
